(19) United States
(12) Patent Application Publication
(10) Pub. No.: US 2025/0307615 A1
(43) Pub. Date: Oct. 2, 2025

(54) GENERATIVE MODEL EVALUATION WITH ENCODER TRAINING

(71) Applicant: THE TORONTO-DOMINION BANK, TORONTO (CA)

(72) Inventors: Anthony Lawrence Caterini, TORONTO (CA); Jesse Cole Cresswell, TORONTO (CA); Brendan Leigh Ross, TORONTO (CA); Rasa Hosseinzadeh, TORONTO (CA); Gabriel Loaiza Ganem, TORONTO (CA); Maksims Volkovs, TORONTO (CA)

(21) Appl. No.: 19/093,576

(22) Filed: Mar. 28, 2025

Related U.S. Application Data
(60) Provisional application No. 63/571,296, filed on Mar. 28, 2024.

(51) Int. Cl. G06N 3/0475; G06N 3/0455; G06N 3/08

(52) U.S. Cl. CPC G06N 3/0475; G06N 3/0455; G06N 3/08

(57) ABSTRACT

A generative model is evaluated by combining the generative model with an encoder architecture to form an autoencoder. The encoder architecture is trained with the autoencoder while fixing parameters of the generative model, enabling the encoder to learn parameters for reproducing data samples. The generative model is scored by determining the similarity of data points when processed by the trained autoencoder, such as a reconstruction error of the data points when reproduced by the autoencoder. The same encoder architecture may be used to evaluate multiple generative models, such that the different generative models may train different parameters for the encoder architecture. The generative models that are more effective at training the encoder to reproduce the data samples may be considered a higher-quality generative model. This generative model quality score may also provide an effective, calculable upper bound on the Wasserstein distance.

### CROSS REFERENCE TO RELATED APPLICATION

This application claims the benefit of U.S. Provisional Patent Application No. 63/571,296, filed Mar. 28, 2024, which is incorporated by reference herein in its entirety for all purposes.

### BACKGROUND

This disclosure relates generally to evaluating generative models and more particularly to evaluating generative model quality with co-trained encoders.

Generative models learn to create new data samples based on a data set of training examples. Across various domains including tabular, image, and text data, generative models have become increasingly complex and effective at modeling underlying data distributions and creating new data points consistent with these data distributions. However, as these generative models increase in capability, it is often difficult to effectively evaluate the quality of generative models and determine whether one generative model outperforms another. Certain types of generative models may be evaluated by attempting to assess higher-level features that may be calculated in the generated data point or to measure similarity in distribution for a source data distribution and a data distribution generated by the generative model.

However, these approaches typically evaluate generative models with metrics that are limited to particular data types (e.g., certain image features), may not generalize to different distributions of data, or may be excessively complex to calculate. Effectively determining the quality of generative models across different types of data and with generative models having various types of architectures and data distributions is an ongoing challenge, making it difficult to determine whether one generative model more effectively represents a data set than another.

### SUMMARY

To improve evaluation of generative models, a generative model quality score is determined for a trained generative model by training an encoder model with the (pre-trained) generative model. The encoder model transforms data points from the data space generated by the model to a sampling space from which the generative model creates samples. The trained generative model in combination with the encoder can thus be treated as an autoencoder where the “decoder” is the generative model. The “autoencoder” is trained with a set of encoder training data that trains the encoder and while maintaining the parameters of the generative model, attempting to minimize an error between the encoder training data and the data points output by the generative model. After training the encoder, the generative model may then be scored by evaluating the difference in a set of evaluation data points and the output data points when processed by the autoencoder. Because the generative model is fixed, the extent to which the autoencoder can learn to reconstruct the data points (while training the encoder) is limited by the quality of the generative model. This enables the trained autoencoder to estimate an upper bound on a Wasserstein distance between the evaluation data points, and the generated data points and use the estimated Wasserstein distance to evaluate the quality of the generative model.

To evaluate multiple generative models and select a preferred generative model between multiple competing generative models, a common encoder architecture is trained for each generative model. A respective generative model quality score is evaluated with the respective trained encoders, allowing the score to represent the extent to which each generative model may successfully train an encoder to reproduce data points. Although the different autoencoders obtain different parameters for the same encoder architecture, by using the same encoder architecture, each generative model is evaluated with an encoder architecture expected to have the same capacity to represent data in the autoencoder, such that differences in scores can be attributable to the different generative models. As the scores estimate a limit on the generative models' quality, the scores for each generative model may then be used to select a preferred generative model. In various embodiments, the generative models, encoder models, and scoring may proceed with different data sets or may be similar data sets.

Because this process enables effective evaluation of generative models using differences in data point reconstruction, this approach may evaluate different types of generative models, including those trained with various types of processes and architectures. Similarly, this process may be agnostic to the data type being generated, such that it may be applied to various types of data, such as tabular, image, and text data.

In addition, the particular encoder architecture used to evaluate the generative models may be selected from among a plurality of candidates. To do so, various candidate encoder architectures may be paired with a particular generative model for training to determine a generative model quality score obtainable from each encoder architecture. In general, the candidate encoder architecture capable of obtaining the best score represents the encoder architecture that may best reproduce the data points. That encoder architecture may then be used for scoring and evaluation of multiple generative models.

### BRIEF DESCRIPTION OF THE DRAWINGS

FIG. 1 illustrates a model evaluation system for evaluating generative models, according to one embodiment.

FIG. 2 shows an example of data points and a learned probability density for a generative model.

FIG. 3 shows an example generation of a generative model quality score for a trained generative model, according to one embodiment.

FIG. 4 shows an example dataflow for comparing trained generative models, according to one embodiment.

FIG. 5 shows an example dataflow for selecting an encoder architecture, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

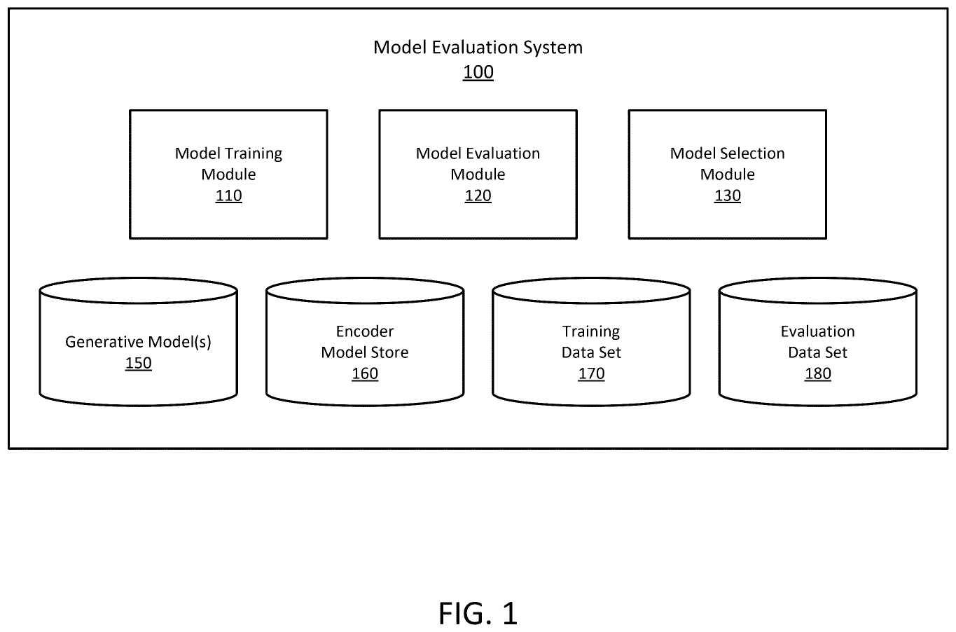

FIG. 1 illustrates a model evaluation system 100 for evaluating generative models, according to one embodiment. In general, generative models are trained on a set of real data to generate synthetic or “fake” data having a similar distribution to the data set on which the generative model was trained. Generative models typically include sampling from an underlying sampling space from which output data samples may be generated. As one metric for evaluating the quality of the generative models, a trained generative model may be evaluated based on the quality of autoencoder that can be trained with the generative model operating as a decoder. To do so, an autoencoder is created with the trained generative model and an encoder architecture that is trained with the generative model. The quality of the trained autoencoder (i.e., the extent to which evaluated data points are similar when processed by the autoencoder) may be used to evaluate the quality of the generative model. Particularly, multiple generative models may be evaluated using the same encoder architecture to determine the quality of each trained generative model based on the respective autoencoders using that trained generative model and the encoder architecture.

The model evaluation system 100 shown in FIG. 1 includes various components that may be used to select evaluate generative models. In various embodiments, certain components may be omitted or functions performed by alternate systems in communication with the model evaluation system 100. In addition, various aspects of the invention may be performed by processing units (e.g., CPUs, GPUs), that are located on various separate devices. As such, the various data stores and processing components discussed with respect to FIG. 1 may include various systems and data stores operating in conjunction with one another across various communication systems and may include cloud or other distributed implementations. Rather, the features of the model evaluation system 100 are shown and discussed with respect to one device for convenience and may be differently configured in various embodiments.

The model evaluation system 100 includes a number of generative models 150 to be evaluated. In general, the generative models 150 (and the respective samples) may be pre-trained or pre-existing, and in some embodiments may be trained by the model evaluation system 100 using a model training module 110. Each generative model 150 may thus be trained to generate data samples similar to a training data set 170. Each of the generative models 150 includes computer modeling layers according to the particular architecture of the respective generative model 150 and may include a plurality of sequential layers with trainable parameters, such as convolutional layers, pooling layers, neural layers, fully connected layers, activation layers, recurrent layers, and so forth. During training by the model training module 110, the generative models 150 are trained according to a suitable training method and may include various model training methods such as gradient descent, stochastic gradient descent, and similar optimization techniques. As examples, the generative models 150 may include diffusion models, generative adversarial networks, variational autoencoders, normalizing flows, Transformer-based models, consistency models, and the like. In general, these models aim to generate “similar” data samples to the “real” data in the training data set 170 without memorizing the training data itself, and are generally intended to also learn a distribution, such that the types of data samples randomly generated by the generative models should be similar to the types of data samples in the training data set 170.

The training data set 170 includes a database of data samples of a particular type to train the generative models. The training data set 170 varies in different embodiments and may include, for example, images, video, text, audio, and so forth. In the examples discussed herein, the various data sets and models use image data. The training data set 170 may include publicly-available or open-source data sets and for image data may include data sets such as CIFAR10, ImageNet, Flickr-Faces-HQ (FFHQ), Large-scale Scene Understanding (LSUN), and so forth.

After training, samples are drawn from the generative models 150 to obtain generated data samples associated with each generative model 150. The generated data samples may thus represent the output of the generative models to be evaluated and determine the quality of the respective generative models 150 based on the data set used to train the models.

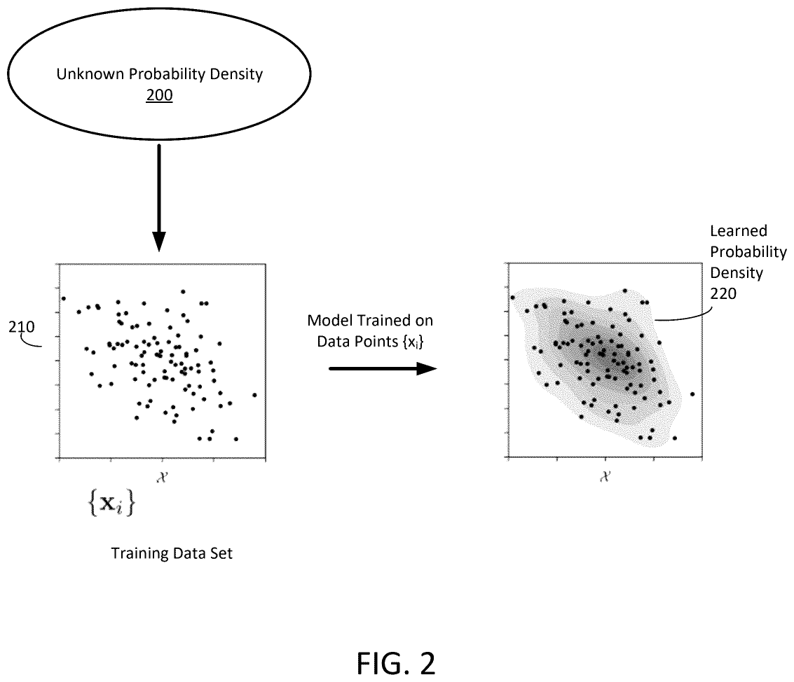

FIG. 2 shows an example of data points and a learned probability density 220 for a generative model. In general, data points used to train a generative model are considered to be drawn or sampled from an unknown probability density 200. Each of the data points 210 has a set of values in the dimensions of an output space. For example, an image for a 256×256 resolution image in a training data set may have three color channels for each pixel and designate a value for each color channel for each pixel. The particular values of the color channels of the pixels (of the 256×256 pixels in the image resolution) in the image thus represent a “position” of the image in the output space.

Formally, the data points 210 may also be represented as a set of points {xᵢ}drawn from the unknown probability density 200 (p_{*}^{X}). The model is trained to learn a learned probability density 220 probability density as represented by trained/learned parameters of the computer model based on the data points {xᵢ}. Many generative models, such as GANs, normalizing flows, and variational autoencoders, operate by sampling (Z˜p^{Z}) from a prior distribution p^{Z} (usually a standard Gaussian) in a sampling space (which is typically in a different dimensionality than the output data space X). Then, the sampled point is transformed through a generative network g^{θ} (e.g., a neural network or generator in the context of GANs), so that, once the network is trained, X=g_{θ*}(Z) will be a sample from the model (e.g. an image). Here, θ denotes the parameters of the model and θ* denotes the parameter values of the trained model. These models implicitly define the learned probability density 220 (p_{θ*}^{X}) of the model, intended to approximate the unknown probability density 200 based on the data samples 210.

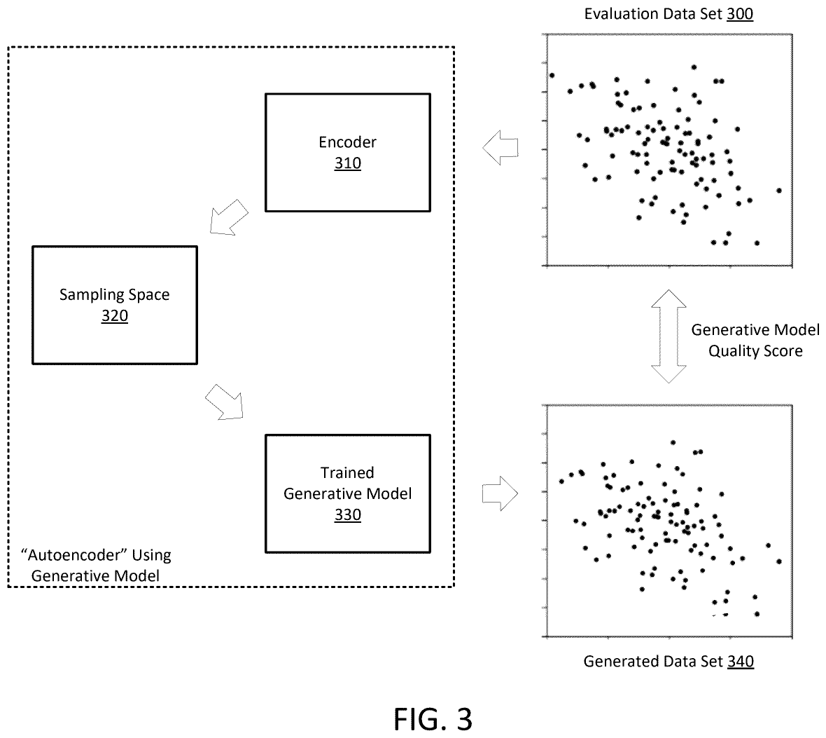

Returning to FIG. 1, the generative models 150 may be evaluated for their quality according to various metrics by a model evaluation module 120. In particular, the model evaluation module 120 includes one metric for evaluating generative models 150 by training an encoder model architecture with the generative model being evaluated. The model evaluation module 120 may form an autoencoder with the generative model and an encoder architecture, such that the encoder may transform data points to the sampling space of the generative model, and the generative model may transform the points in the sampling space back to the output space. After training of the encoder in this structure, the generative model is evaluated based on the similarity of the output data points to the input data points. Details of this metric are discussed further below, particularly with respect to FIGS. 3-5. In various embodiments, the model evaluation module 120 selects an encoder architecture from an encoder model store 160 for training with the generative model. The encoder model store 160 may include various encoder architectures that may be used to evaluate generative models 150. In some embodiments, the model evaluation module 120 may select an encoder architecture for use with a particular generative model or set of generative models for evaluation as discussed further below.

In some embodiments, the model evaluation module 120 trains encoder architectures with a generative model using a set of encoder training data that may differ from the set of training data 170 used to train the generative model 150. In addition, in certain embodiments, an evaluation data set 180 may be used to determine the generative model store after training of the encoder architecture for a particular generative model 150.

In addition to the metric as further discussed below, the model evaluation module 120 may use additional evaluation and performance metrics to assess the quality of generative models 150. For example, the model evaluation module 120 may apply various metrics to evaluate generated data sample variation, memorization, and production of relevant features. As one example, these metrics may include applying pre-trained encoders to generated samples by the generative models to obtain representations of the generated samples in latent spaces and applying a scoring function to the latent space representations. These additional metrics features may be combined with the generative model quality score as discussed below to evaluate generative models 150.

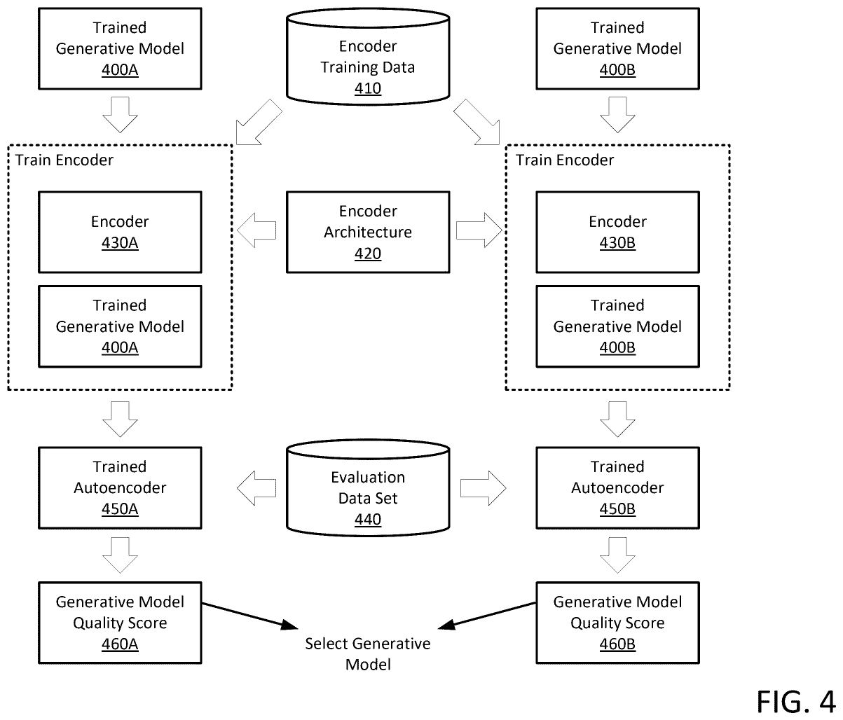

A model selection module 130 may be used to evaluate multiple generative models 150 and determine a preferred generative model. The model selection module 130 may obtain metrics and other scoring of the respective generative models from the model evaluation module 120 and identify which generative model 150 has a preferred score. In some embodiments, the generative models 150 are scored during development of the generative models 150, for example, to evaluate varying generative architectures, training processes, model types, and so forth. The evaluation by the model selection module 130 may then be used to select a preferred model, which may form the basis for further generative model development or for deployment of a preferred model to additional systems to serve requests for generating data samples. One example for evaluating generative models is discussed below with respect to FIG. 4.

FIG. 3 shows an example generation of a generative model quality score for a trained generative model 330, according to one embodiment. As discussed above, a trained generative model 330 generally obtains samples (e.g., from a Gaussian) from a sampling space 320 and applies parameters of the trained generative model 330 to generate data points in an output space. To measure the quality of the trained generative model 330, the trained generative model is used in conjunction with an encoder 310 to form an autoencoder. The encoder 310 receives data points in the output space and encodes the data points to a representation in the sampling space 320. The encoded data points in the sampling space 320 are then processed by the trained generative model 330 to obtain positions in the output space. The encoder 310 may be trained with respect to a set of training data to obtain parameters for the encoder 310 that optimize reproduction of the input data points. By training the encoder 310 to learn parameters for converting data points from the output space to the sampling space 320, the quality of the trained generative model 330 may be estimated based on the capacity of an autoencoder that uses the trained generative model 330.

The quality of the generative model may be determined as a generative model quality score by applying this “autoencoder” using the trained generative model. Particularly, a set of data points for an evaluation data set 300 may be processed by the autoencoder to obtain a generated data set 340, with points in the generated data set 340 corresponding to points in the evaluation data set 300. The difference between these points (e.g., as a reconstruction error) may then be used as a generative model quality score. That is, after training the encoder 310, the extent to which an autoencoder using the trained generative model 330 can reproduce the data points in the evaluation data set 300 in the generated data set 340 may quantify the quality of the generative model.

In particular, by using the generative model as part of a two-step autoencoder (i.e., encoding points to the sampling space and then “decoding” points with the generative model to the output space), the difference in data points can estimate the “distance” between the unknown probability density of the data points p_{*}^{X} and the probability density p_{θ*}^{X} represented by the trained generative model parameters. The generative model quality score using the difference in position of data points in the evaluation data set 300 and generated data set 340 may provide an upper bound on the Wasserstein distance between the different probability densities. Although typically the Wasserstein distance is too difficult to compute for many generative model data types (e.g., for image data sets), because this approach can define an upper bound to the Wasserstein distance by training the encoder 310 and processing the evaluation data set 300, the Wasserstein distance can be effectively estimated (as an upper bound) tractably and with reduced computational requirements.

In one embodiment, the generative model quality score is determined based on:

$$L ( ϕ ; {g}_{{θ}^{*}} ) = {𝔼}_{X ∼ {p}_{*}^{X}} [ {\vert \vert X - {g}_{{θ}^{*}} ( {f}_{ϕ} ( X ) ) \vert \vert}_{2}^{2} ] \qquad EQUATION 1$$

in which:
X is the set of data points;
f_{ϕ} is an encoder having parameters ϕ;
g_{θ*} is the trained generative model having parameters θ*; and
L(ϕ; g_{θ*}) is a loss function based on the encoder parameters and the trained generative model.

In some embodiments, the parameters of the encoder are trained using encoder training data. The parameters of the encoder may be trained using a suitable loss function, such as the loss function of Equation 1. In some embodiments, the encoder 310 is trained using a set of encoder training data, and a different set of data is used as the evaluation data set 300 for evaluating the trained generative model 330. In one or more embodiments, the evaluation data set 300 is the same as the encoder training data. In addition, the encoder training data may be different from or the same as the training data used to train the trained generative model 330. The generative model quality score may be used to compare the performance of different generative models.

FIG. 4 shows an example dataflow for comparing trained generative models, according to one embodiment. This example dataflow and related processing may be performed, for example, by a model evaluation system 100 and its related modules as shown in FIG. 1, such as model evaluation module 120. Generative model quality scores 460A-B may be generated for trained generative models 400A-B. Each of the trained generative models 400A-B may use different model architectures, training methods, and so forth. In particular, the trained generative models 400A-B, although used with an encoder architecture 420 to train respective encoders 430A-B, need not be trained in conjunction with any encoder, and may include energy-based, adversarial, and other generative model types and training approaches.

The encoder architecture 420 may be used with each trained generative model 400A-B to train parameters for respective encoders 430A-B using a set of encoder training data 410. During training of each encoder 430A-B, the parameters of the trained generative models 400A-B may be kept constant, such that a training loss from the encoder training data is used to modify parameters of respective encoders 430-B. After training, the respective pair of encoder 430 and trained generative model 400 form a trained autoencoder 450. Particularly, trained autoencoder 450A includes encoder 430A and trained generative model 400A, while trained autoencoder 450B includes encoder 430B and trained generative model 400B.

To evaluate the trained generative models 400A-B, the evaluation data set 440 is applied to the respective trained autoencoders 450A-B to determine generative model quality scores 460A-B. As the encoders 430A-B share the same encoder architecture 420, the difference in ability of the trained generative models 430A-B to reconstruct data points in the evaluation data set 440 reflects the comparative quality of the trained generative models 400A-B. The generative models' quality scores 460A-B may then be used as one or more metrics for evaluating the generative models and selecting one of the generative models, e.g., for use or for further evaluation or training.

By evaluating the generative models with an autoencoder and a reconstruction loss, this approach may be applied to a variety of data types and without requiring additional detection of features or other characteristics of the data types. In addition, in some embodiments the encoder architecture used to evaluate the generative models may also be selected from among a set of candidate architectures.

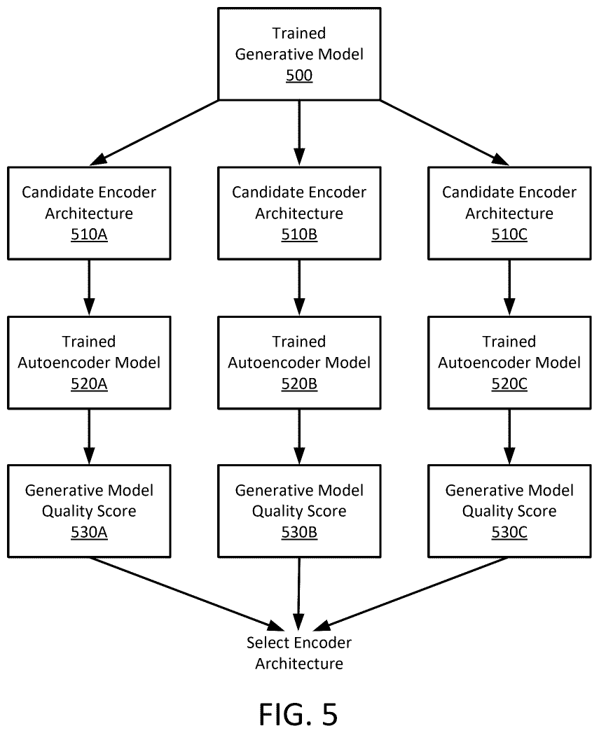

FIG. 5 shows an example dataflow for selecting an encoder architecture, according to one embodiment. A number of candidates encoder architectures 510A-C may be considered for use as the encoder architecture (e.g., encoder architecture 420) used to evaluate generative models. Each candidate encoder architecture 510A-C may provide a unique number of computer model layers, complexity, number of parameters, and so forth.

Rather than varying the trained generative model 500, in this instance the same trained generative model 500 may be used to train encoders for each of the candidate encoder architectures 510A-510C, resulting in corresponding trained encoder models 520A-C. The various candidate encoder architectures 510A-C may be trained with the same training set, e.g., encoder training data 410. Each of the trained encoder models 520A-C is then evaluated with an evaluation data set to determine a generative model quality score 530A-C. As the various trained encoder models 520A-C share the same trained generative model 500 and training data, the various candidate encoder architectures 510A-C can be evaluated according to the extent to which the candidate encoder architectures can effectively reproduce the evaluation data. The generative model quality score 530A-C thus indicates the candidate encoder architecture 510A-C that may be best trained to characterize the training data. As a lower reconstruction error represents a better score, a candidate encoder architecture 510 capable of learning the lowest reconstruction error is expected to present the lowest upper bound on the Wasserstein distance of the autoencoder error and thus a better estimate of the quality of the trained generative model 500.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computing system for evaluating generative models, comprising:
a processor; and
a non-transitory computer-readable storage medium having instructions executable by the processor for:
identifying a first generative model and a second generative model;
training a first autoencoder on a set of encoder training data using an encoder architecture and the first generative model, the first generative model being held constant during training of the first autoencoder;
training a second autoencoder on the set of encoder training data using the encoder architecture and the first generative model, the second generative model being held constant during training of the second autoencoder;
determining a first score for the first generative model based on the first autoencoder applied to an evaluation data set;
determining a second score for the second generative model based on the second autoencoder applied to the evaluation data set; and
selecting the first generative model or the second generative model for deployment as an active model for subsequent data generation based on the first score and the second score.

2. The system of claim 1, wherein the first score and second score are a reconstruction loss of the evaluation data set.

3. The system of claim 1, wherein the instructions executable by the processor for determining the encoder architecture comprises:
training a plurality of candidate encoder architectures with a trained generative model;
scoring the plurality of candidate encoder architectures based on a reconstruction loss of the trained plurality of encoder architectures; and
selecting the encoder architecture from the plurality of candidate encoder based on the scoring.

4. The system of claim 1, wherein the evaluation data set is the same as the encoder training set.

5. The system of claim 1, wherein the first generative model and the second generative model are trained with the encoder training set.

6. The system of claim 1, wherein the first generative model and the second generative model have different architectures.

7. The system of claim 1, wherein determining the first score and the second score comprises scoring based on a reconstruction error of the evaluation data set.

8. The system of claim 1, wherein the first score and second score estimate a Wasserstein distance.

9. The system of claim 1, wherein the first generative model and second generative model are configured to generate tabular, image, or text data.

10. A computer-implemented method for evaluating generative models, comprising:
identifying a first generative model and a second generative model;
training a first autoencoder on a set of encoder training data using an encoder architecture and the first generative model, the first generative model being held constant during training of the first autoencoder;
training a second autoencoder on the set of encoder training data using the encoder architecture and the first generative model, the second generative model being held constant during training of the second autoencoder;
determining a first score for the first generative model based on the first autoencoder applied to an evaluation data set;
determining a second score for the second generative model based on the second autoencoder applied to the evaluation data set; and
selecting the first generative model or the second generative model for deployment as an active model for subsequent data generation based on the first score and the second score.

11. The computer-implemented method of claim 10, wherein the first score and second score are a reconstruction loss of the evaluation data set.

12. The computer-implemented method of claim 10, wherein the method further comprises:
training a plurality of candidate encoder architectures with a trained generative model;
scoring the plurality of candidate encoder architectures based on a reconstruction loss of the trained plurality of encoder architectures; and
selecting the encoder architecture from the plurality of candidate encoder based on the scoring.

13. The computer-implemented method of claim 10, wherein the evaluation data set is the same as the encoder training set.

14. The computer-implemented method of claim 10, wherein the first generative model and the second generative model are trained with the encoder training set.

15. The computer-implemented method of claim 10, wherein the first generative model and the second generative model have different architectures.

16. The computer-implemented method of claim 10, wherein determining the first score and the second score comprises scoring based on a reconstruction error of the evaluation data set.

17. The computer-implemented method of claim 10, wherein the first score and second score estimate a Wasserstein distance.

18. The computer-implemented method of claim 10, wherein the first generative model and second generative model are configured to generate tabular, image, or text data.

19. A non-transitory computer-readable medium for evaluating generative models, the non-transitory computer-readable medium comprising instructions that are executable by a processor for:
identifying a first generative model and a second generative model;
training a first autoencoder on a set of encoder training data using an encoder architecture and the first generative model, the first generative model being held constant during training of the first autoencoder;
training a second autoencoder on the set of encoder training data using the encoder architecture and the first generative model, the second generative model being held constant during training of the second autoencoder;
determining a first score for the first generative model based on the first autoencoder applied to an evaluation data set;
determining a second score for the second generative model based on the second autoencoder applied to the evaluation data set; and
selecting the first generative model or the second generative model for deployment as an active model for subsequent data generation based on the first score and the second score.

20. The computer-readable medium of claim 19, wherein the first score and second score are a reconstruction loss of the evaluation data set.
